(19) United States
(12) Patent Application Publication
(10) Pub. No.: US 2007/0010237 A1
(43) Pub. Date: Jan. 11, 2007

(54) Mac-level protection for networking extended-range and legacy devices in a wireless network

(75) Inventors: Vincent K. Jones, Redwood City, CA (US); Alireza Raissinia, Monte Sereno, CA (US); Guido Robert Frederiks, Monte Sereno, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Airgo Networks, Inc., Palo Alto, CA (US)

(21) Appl. No.: 11/175,971

(22) Filed: Jul. 5, 2005

(51) Int. Cl. H04Q 7/20

(52) U.S. Cl. 455/422.1

(57) ABSTRACT

The invention provides solutions, including devices, systems, methods and software, for allowing interoperability between legacy stations and extended-range stations in a wireless network. Merely by way of example, an access point might be configured to transmit communications (such as beacon frames, broadcast frames, multi-cast frames, etc.) in a first mode and/or a second mode. The first mode might not employ extended-range technology, such that communications transmitted in the first mode can be received and/or interpreted by legacy stations, while the second mode might employ extended-range technology, such that communications transmitted in the second mode can be received by extended-range stations outside the range of basic-range communications. As another example, the access point might be configured to establish transmission “windows,” such that legacy stations are free to transmit during a first time period, in which extended-range stations are prohibited from transmission, followed by a second time period, in which extended-range stations are free to transmit, while transmission from legacy stations is prohibited.

### BACKGROUND OF THE INVENTION

The present invention relates generally to wireless networks, and in particular to techniques for allowing for interoperation of extended-range wireless stations and traditional wireless stations.

The flexibility of wireless networks has resulted in their ever-increasing popularity. By their nature, wireless networks can provide a relatively low-cost networking solution when compared with wired alternatives. Moreover, wireless networks can support mobile nodes, nodes in locations inaccessible by wired media and the like. Unfortunately, however, wireless networks are relatively more susceptible to environmental conditions (such as interference) than their wired counterparts. As a result, wireless networks traditionally have lagged behind wired networks in terms of both network throughput and transmission distance.

Accordingly, much effort has gone into providing higher-throughput and longer-range wireless solutions. For example, while the 802.11b standard promulgated by the IEEE specified a 2 Mb/s (megabit/second) throughput, later-developed standards (such as 802.11g and 802.11a) specify higher data rates, such as 54 Mb/s. Developing standards, such as 802.11n, show potential to provide even higher rates.

Similarly, the industry has begun to develop solutions that provide increased transmission range for wireless networks. For instance, the use of multiple transmission and/or reception antennas on devices (including access points, stations, etc.) can provide increased range. One such technology, known as multiple-input-multiple-output (“MIMO”) can provide increased data rates and/or transmission range. A complementary technology, space-time block coding (“STBC”) provides transmitter coding over both the time and spatial dimensions, given the presence of multiple transmit and/or receive antennas. Developing standards (including, for example, the draft 802.11n specification) most likely will employ these and/or other techniques to allow for longer-range, higher-throughput networks.

An area of concern, however, is the backward-compatibility of such networks. It is desirable to allow a given network to employ such new technologies without sacrificing interoperability with existing (“legacy”) devices. For example, many laptop computers are equipped with on-board wireless networking capability, and if networks employing new technologies fail to provide interoperability with such legacy capabilities, users will be forced to upgrade and/or replace their laptop computers.

Of particular concern is the scenario in which an extended-range device is operating on the same wireless local area network (“WLAN”) as a legacy device. Assuming the extended-range device is outside the range of traditional wireless technology (i.e., that the extended-range device requires the use of STBC or some other extended-range technology in order to communicate with the access point managing the WLAN), it will not receive any traditional communications transmitted by the access point, so the access point will need to employ some extended-range technology to communicate with the extended-range device. Conversely, the legacy device, which must be within the range supported by traditional wireless technology, will not be able to receive and/or interpret any communications employing extended-range technology. Moreover, depending on the network topology, it is likely that the extended-range device and the legacy device will not be aware of one another.

This situation prevents the effective operation of the network, since any network control communication (beacon frames, clear-to-send frames, etc.) transmitted by the access point will be received by the legacy device or the extended-range device, but not by both. Moreover, there is an increased risk of network collisions, since neither the legacy device nor the extended-range device likely will be able to detect when the other is transmitting.

Hence, there is a general need for solutions providing interoperability between devices employing extended-range technologies and those unable to employ such technologies.

### BRIEF SUMMARY OF THE INVENTION

The invention provides solutions, including devices, systems, methods and software, for allowing interoperability between legacy stations (and other basic-range stations) and extended-range stations in a wireless network. In particular embodiments, the invention implements MAC layer protection (including, without limitation, traditional MAC layer control frames) to provide such interoperability. Merely by way of example, in an embodiment, an access point may be configured to transmit control communications (such as beacon frames, broadcast frames, multi-cast frames, etc.) in a first mode and/or a second mode. The first mode might not employ extended-range technology, such that communications transmitted in the first mode can be received and/or interpreted by basic-range stations, while the second mode might employ extended-range technology, such that communications transmitted in the second mode can be received by extended-range stations outside the range of basic-range communications.

To cite but one example, consider an access point that supports communications in both an 802.11b mode and an extended-range 802.11n mode utilizing space-time block coding. Communicating with the access point are two stations: a first station that supports only 802.11b and is within a range of the access point that allows communication using 802.11b, and a second station that supports 802.11n (with space-time block coding), that is outside 802.11b range but within the extended range supported by 802.11n (with space-time block coding). The access point, in order to provide connectivity with both stations, communicates with the first station using 802.11b and communicates with the second station using 802.11n (with space-time block coding). In this example, the access point transmits a beacon frame first in 802.11b and then in 802.11n (or vice-versa), such that the beacon frame can be received by both stations.

As another example, the access point might be configured to establish (again, perhaps through the use of MAC layer control frames) transmission “windows,” such that basic-range stations are free to transmit during a first time period, in which extended-range stations might be prohibited from transmitting, followed by a second time period, in which extended-range stations are free to transmit, while transmission from basic-range stations may be prohibited.

An exemplary device (which might comprise a wireless access point) may be used in a wireless network comprising a wireless access point and a plurality of wireless stations. The plurality of wireless stations might comprise one or more basic-range wireless stations configured to communicate via a basic-range mode of communication and/or one or more extended-range wireless stations, some or all of which are configured to communicate via an extended-range mode of communication. The device thus may provide interoperability of the plurality of wireless stations.

In a set of embodiments, the device comprises a communication system, which is configured to provide wireless communication with the legacy wireless station(s) and/or the extended-range wireless station(s). In some embodiments, the device comprises one or more processors in communication with the communication system, as well as a computer readable medium, which may comprise a set of instructions executable by the processor(s).

In one embodiment, the set of instructions provides instructions for transmitting a communication in a basic-range mode for reception by the legacy wireless station(s), and/or instructions for transmitting the communication in an extended-range mode for reception by the extended-range wireless station(s). The communication may be a communication control frame (such as a MAC layer frame), a beacon frame, a broadcast message, a multicast message, and/or the like.

In another embodiment, the instructions comprise instructions for setting a first network allocation vector at an extended-range wireless station, instructions for resetting a second network allocation vector at a legacy wireless station. The instructions might further comprise instructions for receiving a communication transmitted by the legacy wireless station. Similarly, in some cases, the instructions may comprise instructions for setting the second network allocation vector, resetting the first allocation vector and/or receiving a communication transmitted by an extended-range station. In a particular set of embodiments, setting and/or resetting the network allocation vectors might relate to transmitting communication control frames (which may include, without limitation, MAC layer control frames, such as CTS frames, CTS_to_Self frames, and/or CF_End frames, to name but a few examples.)

In a further embodiment, the instructions comprise instructions for transmitting a first communication in a first mode. The first communication might be operable to set a network allocation vector at a first of the plurality of wireless stations (e.g., the wireless stations might be programmed to set their NAV values in response to receipt of the first communication). In some embodiments, the instructions further comprise instructions for transmitting a second communication in a second mode for reception by a second of the plurality of stations, and/or instructions for transmitting a third communication in the first mode. The third communication may be operative to reset the network allocation vector, indicating that the device has completed the second communication. In some cases, the first mode and the second mode are each selected from a group consisting of a basic-range mode of communication and an extended-range mode of communication. In some cases, various stations might be configured to communicate with the basic-range mode but might not be able to receive the extended-range mode, and/or may be configured to communicate with the extended-range mode but reside outside the range of the basic-range mode, such that they cannot receive basic-range mode communications).

Another set of embodiments provides wireless networks, including, without limitation, networks that employ devices similar to those discussed above. An exemplary network comprises a first wireless station configured to transmit a first communication via a first mode of communication. The first communication may indicate that the first wireless station has data to transmit. The network may further comprise a second wireless station configured to communicate via a second mode of communication and/or a wireless access point. The wireless access point may comprise instructions for receiving the first communication and/or instructions for transmitting a second communication via the second mode. The second communication may indicate that wireless stations other than the first wireless station should not transmit. The wireless access point may comprise further instructions for transmitting the second communication in the first mode, which may further indicating that the first wireless station may transmit the data. The first wireless station may be further configured to transmit the data upon receiving the second communication. In a set of embodiments, the first mode and the second mode are each selected from a group consisting of a basic-range mode of communication and an extended-range mode of communication.

A further set of embodiments provides methods of providing interoperability between wireless stations, including, without limitation, methods that can be implemented by the devices and/or networks described above.

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and is enclosed in parentheses to denote one of multiple similar components. When reference is made to a reference numeral without specification to an existing sublabel, it is intended to refer to all such multiple similar components.

### BRIEF DESCRIPTION OF THE DRAWINGS

FIG. 1 illustrates a wireless network in accordance with various embodiments of the invention.

FIG. 2 is a process flow diagram illustrating an exemplary method of managing a wireless network, in accordance with various embodiments of the invention.

FIG. 3 is a process flow diagram illustrating an exemplary method of managing communications in a wireless network, in accordance with various embodiments of the invention.

FIG. 4 is a timing diagram illustrating a sequence of wireless communications according to the method of FIG. 3.

FIG. 5 is a process flow diagram illustrating an exemplary method that an access point may use to transmit on a dual-mode network, in accordance with various embodiments of the invention.

FIGS. 6A and 6B are process flow diagrams illustrating exemplary methods for allowing a node on a dual-mode network to transmit data in accordance with various embodiments of the invention.

FIG. 7 is a timing diagram illustrating a sequence of wireless communications according to the method of FIG. 6A.

FIG. 8 is a simplified schematic diagram illustrating a wireless node in accordance with various embodiments of the invention.

### DETAILED DESCRIPTION OF THE INVENTION

The invention provides solutions, including devices, systems, methods and software, for allowing interoperability between legacy stations and extended-range stations in a wireless network. In particular embodiments, the invention implements MAC layer protection (including, without limitation, traditional MAC layer control frames) to provide such interoperability. Merely by way of example, in an embodiment, an access point may be configured to transmit control communications (such as beacon frames, broadcast frames, multi-cast frames, etc.) in a first mode and/or a second mode. The first mode might not employ extended-range technology, such that communications transmitted in the first mode can be received and/or interpreted by legacy stations, while the second mode might employ extended-range technology, such that communications transmitted in the second mode can be received by extended-range stations outside (as well as possibly within) the range of basic-range communications. As another example, the access point might be configured to establish (again, perhaps through the use of MAC layer control frames) transmission “windows,” such that legacy stations are free to transmit during a first time period, in which extended-range stations are prohibited from transmitting, followed by a second time period, in which extended-range stations are free to transmit, while transmission from legacy stations are prohibited.

Wireless networks are typically designed with layers, such as the seven networking layers of the ISO/OSI model. The lowest of these layers is the PHY (physical) layer, concerned with transmitting signals. The next layer that interfaces the PHY layer with higher-level layers is the MAC (medium access control) layer. The MAC layer may be used to provide control signaling to allow efficient use of network resources, including through the use of MAC layer control frames, through which various nodes' access to the network may be managed.

A 802.11 MAC layer generally provides for Carrier-Sense-Multiple-Access (CSMA) protocols for time-division-multiplexing of data traffic. In such a network, data traffic is organized in packets. With CSMA, each radio checks the wireless medium to see if it is being used by others (i.e., if there are others transmitting packets) before using it. As a consequence, it is important that each device be able to accurately measure whether another device is using the medium or not, to avoid interfering with those other devices' media access

As described in further detail below, the present invention contemplates a dual-mode wireless network, where two (or more) modes of communication may be implemented. This may prevent, in some cases, the effective functioning of traditional CSMA protocols. For instance, relatively newer and/or enhanced devices may use a first mode of communication, while legacy devices may use a second mode of communication. In a set of embodiments, the second mode of communication may not be compatible with the first mode of communication—that is, nodes designed to operate in the second mode may not be able to understand communications transmitted using the first mode, and/or vice-versa. Alternatively, while enhanced devices may be able to understand communications transmitted in the first mode, practical constraints may prevent the effective reception by those devices of communications transmitted via the first mode. Merely by way of example, a node might be within range of the access point to use extended-range communications (as described below, for example), but not within effective range to use basic-range communications, such that basic-range communications transmitted by the access point may not be received reliably and/or at all. Hence, the traditional CSMA technique of a station checking the medium for use before transmitting might not prevent packet collisions, since a node transmitting in the extended-range mode will not be able to detect competing transmissions in the basic-range mode, even though both modes may occupy the same spectrum.

In a set of embodiments, all such nodes will be able to understand and comply with traditional MAC layer control frames (at least when transmitted in the appropriate mode), such that these control frames may be used to provide interoperability between nodes operating in two (or more) different modes of communication. For instance, a first control frame may be transmitted in a first mode (for reception by devices operating in that mode), while a second control frame (which might or might not comprise the same control information as the first control frame) may be transmitted in a second mode (for devices operating in that mode). Through the use of various control frames (transmitted in the appropriate mode(s)), an access point can manage node access to the network, providing interoperability even between devices that typically would not be able to communicate on the same wireless network.

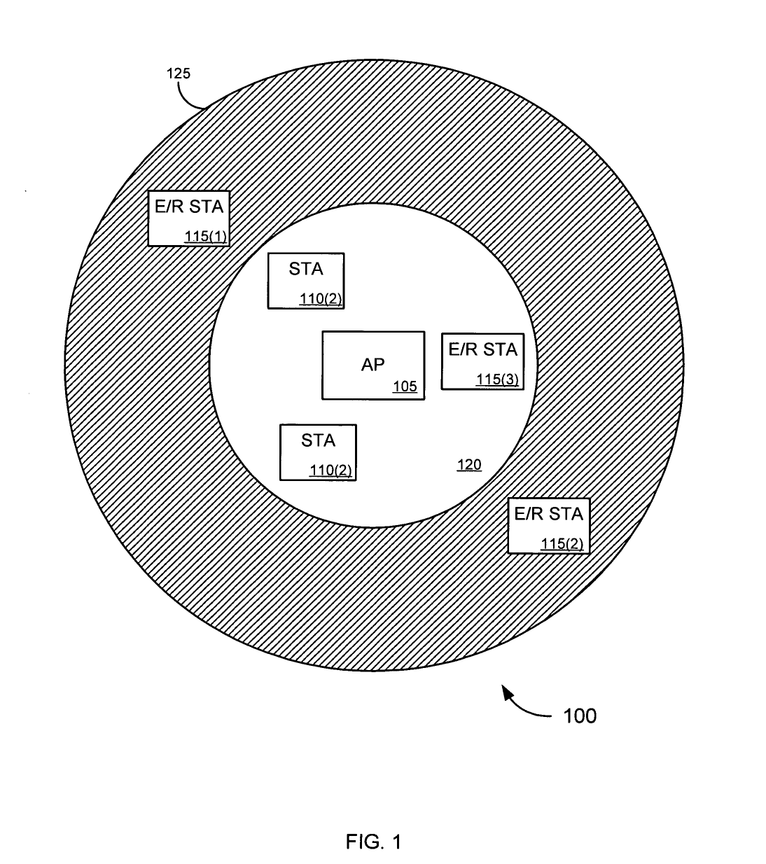

Merely by way of example, FIG. 1 illustrates a dual-mode wireless network 100 in accordance with some embodiments of the invention. The wireless network 100 includes a plurality of nodes, including an access point (“AP”) 105 and stations (“STA”) 110 and 115. As described below some of the stations (“E/R STA”) 115 are stations capable of operating in an extended-range mode. In a set of embodiments, the wireless network 100 is designed to be compliant with one or more of the IEEE 802.11 standards. Merely by way of example, the wireless network might implement a legacy standard (such as 802.11a/b/g) and/or a standard that supports extended-range communications (such as the proposed 802.11n standard with MIMO, STBC and/or other enhanced protocols). Thus, for example, the network 100 might have a first coverage area 120 (which generally will comprise an area around the AP 105 as depicted by FIG. 1, but which will, of course, vary with environmental conditions, such as interfering structures and/or transmissions, etc.) corresponding to the transmission range of nodes employing the legacy standard and a second coverage area 125 (which also is depicted by a circular area around the access point 105 but, again, likely will vary with environmental conditions) corresponding to the transmission range of nodes employing the extended-range standard.

It should be noted, however, that other standards-based and/or nonstandard networks might be substituted therefore to solve problems similar to those solved in the 802.11 environment. Thus, while many of the examples described herein solve the problem of detecting packets (and other tasks) in an environment where 802.11n and 802.11a/b/g nodes are present, the teachings of this disclosure can be used for a system where one or more other protocol standards are used. Further, while the discussion herein often refers to basic-range and extended-range modes of communication, some embodiments allow interoperability of nodes operating in any two (or more) modes of communication, which might otherwise be incompatible.

Generally, the access point 105 may be used to provide connectivity between the stations 110 and 115 and a wired network, such as a local area network (“LAN”), the Internet, etc., as well as among the stations 110 and 115 themselves. In the exemplary network 100, there are two types of stations: basic-range stations 110 (also referred to herein as “legacy stations” or “normal range (non-extended range capable) stations”), which employ a basic communication protocol and must reside within the first range 120 (as that is how the first range is defined) in order to communicate with the AP 105, and extended-range stations, which employ one or more extended-range technologies and thus may reside anywhere within the second range 125 to have connectivity with the AP 105. A variety of range-extending technologies may be implemented in accordance with embodiments of the invention, including, without limitation, MIMO, STBC, diversity combining, duplication of an HT-SF field in a transmission frame, beamforming, and/or the like. In some embodiments, an extended-range station may be configured such that the PHY layer can inform the MAC layer that a frame is an extended-range frame (for example, an extended range frame may have an REXT bit set on, and this bit may be passed to the MAC layer) on the receive side in order to inform the receiving device of the presence of an extended range transmission. In other embodiments, the MAC layer may be unaware of any PHY layer particulars.

As used herein, therefore, the term “extended-range wireless station” means any station that is capable of operating in an “extended-range” mode that employs one or more range-extending technologies (and/or is capable of transmitting and/or receiving communications employing such range). Extended-range wireless stations may operate in accordance with relatively newer standards (such as 802.11n) that specify and/or accommodate such range-extending technologies.

Conversely, the term “basic-range wireless station” (also referred to herein as a “basic wireless station” or a “legacy wireless station”) means any station that operates in accordance with legacy standards (such as 802.11a/b/g, for example) and/or cannot operate in the extended-range mode of the extended-range wireless stations in that particular network. A legacy wireless station thus operates in a “basic-range mode” (also referred to herein as a “basic mode” or “legacy mode”) free of the extended-range technologies employed by the extended-range station. (It should be noted that a legacy station or basic-range station can be any station that operates without the benefit of an extended-range communication mode, irrespective of the protocol that the station uses. Accordingly, legacy or basic-range stations are not limited merely to stations operating in accordance with legacy standards.)

Hence, depending on the embodiment, extended-range wireless stations and legacy wireless stations may operate in accordance with a variety of standards and/or employ a variety of technologies, but the extended-range wireless stations generally will be receiving and/or transmitting communications using a standard not implemented by legacy stations and thus may be able to operate at a relatively greater range from the AP than legacy stations. In some cases, a station 115(3) that is capable of operating as an extended-range station may be within the basic range of the access point. In such a case, the station 115(3) likely will be able to communicate using either a basic-range mode or an extended-range mode (or both), since it is capable of extended-range communications but is also sufficiently near the access point to participate in basic mode communications. It should be understood that the invention can be used in a network with some extended-range stations and some basic-range stations where the basic-range stations might be legacy devices presently known or might be later-developed devices that are nonetheless legacy stations (as that term is used herein) at the time the network is implemented.

Each of the nodes 105-115 generally will be able to both transmit and receive packets over the wireless medium, although the legacy stations 110 and extended-range stations 115, respectively, may use different modes of communication, as noted above. A variety of types of communication between various nodes may be possible, depending on the embodiment. For example, in one arrangement, all communication may be required to go through the AP 105. Thus, if a station 110(1) wishes to transmit a packet to another station 110(2), the transmission must first be sent to AP 105, then relayed to the station 110(2). In another arrangement, a station 110(1) may communicate directly with another station 110(2), without involving the AP 105. (Of course, in some embodiments, a legacy station 110 may not be able to communicate directly with an extended-range station 115, and/or vice-versa, since they might each be using a different communication mode and/or might be unreachable relative to each other, as described herein).

In a set of embodiments, the access point 105 is capable of communicating in both a basic mode and an extended-range mode. Hence, the access point 105 often can communicate with both the legacy stations 110 (and/or any extended-range stations operating in a basic mode, such as station 115(3)) and the extended-range stations operating in extended-range mode (such as stations 115(1) and 115(2)). Hence, the access point 105 may be configured to manage communications among the extended-range stations 115 and the legacy stations, particularly in situations in which the stations cannot communicate directly with one another.

In another set of embodiments, the access point 105 and/or the stations 110, 115 may be configured to implement any of a variety of access control protocols, including, without limitation, one or more protocols designed to prioritize particular transmissions and/or to provide quality of service (“QoS”) guarantees to particular nodes on the network, such as protocols in compliance with the 802.11e standard. Such protocols may be provided to legacy devices, extended-range devices and/or both. Exemplary protocols include, but are not limited to, the hybrid coordination function controlled channel access (“HCCA”) and enhanced distributed channel access (“EDCA”) protocols known in the art.

In some embodiments, a distributed protection mechanism (such as the RTS/CTS exchange mechanism) might be mandated, for example to provide hidden node protection. This can allow various stations (extended-range and/or basic-range) to transmit at any time, provided they have complied with RTS/CTS conventions. In other embodiments, such distributed protection mechanisms might not be mandated (if, for example, certain legacy stations do not use an RTS/CTS mechanism before any data transmission) and/or the access point might manage communications by various stations (e.g., by establishing transmission windows for different types of stations). Examples of each of these types of embodiments are described in more detail below.

A variety of types of wireless nodes are commercially available, many such devices may be used in accordance with embodiments of the invention. In a particular set of embodiments, an access point 105 may be modified and/or configured to support operation in both an extended-range mode and a basic mode. In other embodiments, stations 110, 115 may be standard wireless nodes (perhaps in communication with other devices, such as computers, etc. and/or incorporated within such devices). Merely by way of example, a station may comprise a wireless network card (which might be a PCMCIA card) in communication with a computer. Alternatively and or in addition, a station might comprise a computer with wireless networking capability, such as that provided by chipsets (such as the AGN100™ chipset available from Airgo Networks, Inc.).

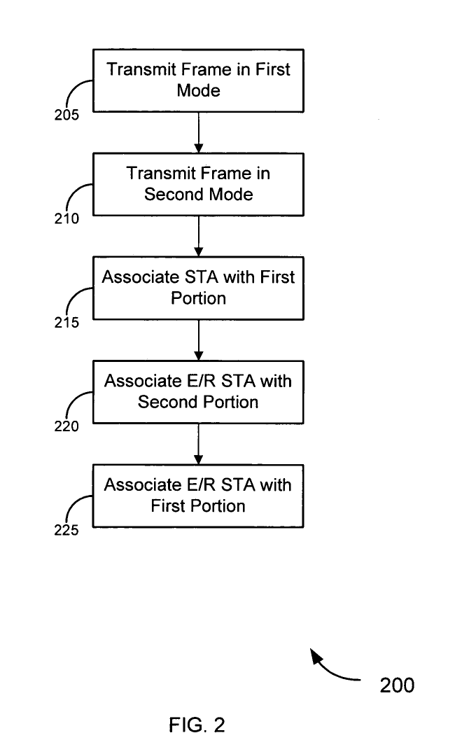

FIG. 2 illustrates a method 200 by which an access point can transmit communications for reception by both extended-range stations and basic-range stations. Those skilled in the art will appreciate, based on the disclosure herein, that in a mixed-mode network (i.e., a network including both basic-range stations and extended-range stations), there are certain transmissions from the access point that need to be received by all participating nodes, including both legacy stations and extended range stations. Merely by way of example, an access point typically will transmit beacon frames in order to associate participating nodes with the access point's network. As another example, an access point may have need to transmit broadcast and/or multicast frames for reception by some or all of the stations.

In a set of embodiments, the method 200 may comprise an access point transmitting a message (which may comprise one or more data packets) in a first mode (block 205), which may be, merely by way of example, an extended-range mode, for reception by stations configured to communicate using the first mode. The access point may then transmit the same message in a second mode, which may be, again by way of example, a basic mode, for reception by stations configured to communicate using the second mode (block 210). Hence, the message may be received by both basic-range stations and/or extended-range stations. In a particular set of embodiments, the message may comprise a frame, including, without limitation, a MAC layer control frame, a beacon frame, etc. Broadcast and/or multicast messages may be transmitted in this manner as well.

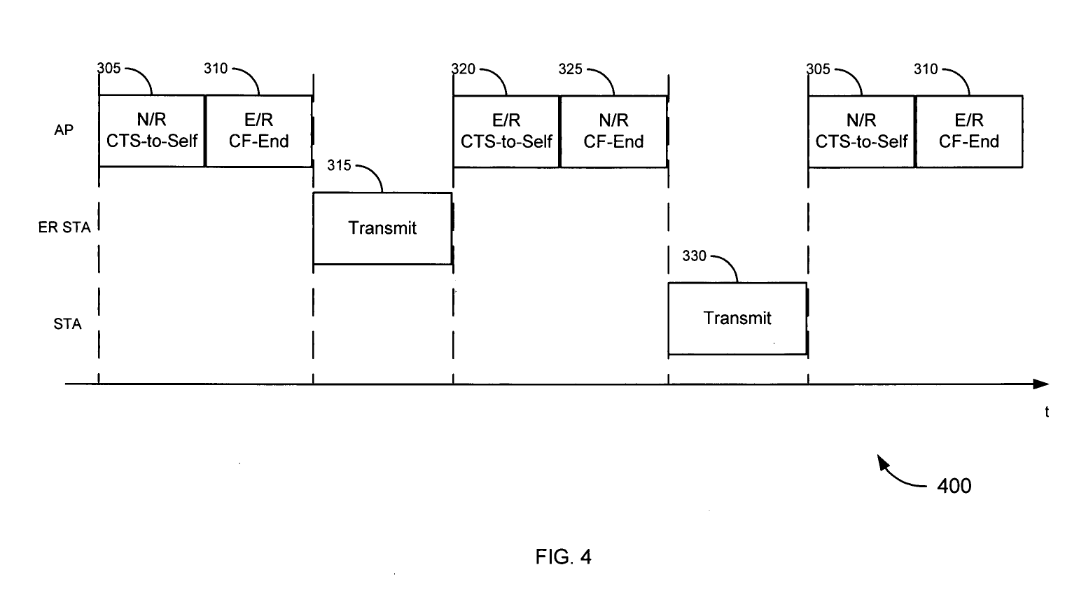

As noted above, in some cases, the method 200 may be used to transmit beacon frames, which may be used to establish participation in a network. Since a network involving both extended-range stations and legacy stations may involve two types of stations unable to communicate using a common mode, the access point may establish two network portions: one for nodes communicating via a legacy mode and one for nodes communicating via an extended-range mode. (Of course, the access point may participate in both network portions, since it is capable of communicating via both modes; in fact, the access point often may serve as a bridge between the two network portions). As described in further detail below, the partitioning of the network into two portions can allow the access point to manage transmission “windows,” such that devices in one portion of the network can transmit in a particular window using a first mode (such as a basic mode), while devices in another portion of the network can transmit in another window using a second mode (such as an extended-range mode), without interfering with one another. In a set of embodiments, when the access point transmits a beacon in a particular mode, the entire beacon interval may considered a transmission in that mode. In other embodiments (such as the embodiment described below with respect to FIG. 4, for example, where the access point manages transmissions), this may not be the case.

The network, then, may be configured to allow various nodes to associate (perhaps using association frames, as is known in the art) with an appropriate portion of the network. Merely by way of example, a beacon frame may be transmitted in a basic mode. In response to this beacon, a basic-range station might transmit an association frame in the basic mode, which the access point will use to associate that basic-range station with a first portion of the network (block 215). Correspondingly, the access point may also be configured to associate extended-range stations with a second portion of the network (block 220), based on an association frame sent in an extended-range mode (e.g., in response to a beacon sent in the extended-range mode). As noted above, in a case in which an extended-range station is within a legacy range of the access point (such as, for example, the station 115(3) illustrated on FIG. 1), that station may be configured to communicate using a legacy-range mode (also referred to herein as a “basic mode”) and/or an extended-range mode. If the station is configured to communicate using a basic mode, it may be added to the first portion of the network, since it is capable of communicating using the same mode as legacy stations (block 225). Optionally, in some embodiments, the station 115(3) may be associated with both network portions.

It should be noted that the partitioning of a wireless network into two portions is discretionary. Merely by way of example, in some embodiments, as described in more detail below, the access point may require all stations to adhere to an RTS/CTS procedure prior to transmitting. In such a case, partitioning the network is not necessary (although it still may be performed) because the RTS/CTS procedure will prevent network collisions even if the access point has not partitioned the network and/or established transmission windows.

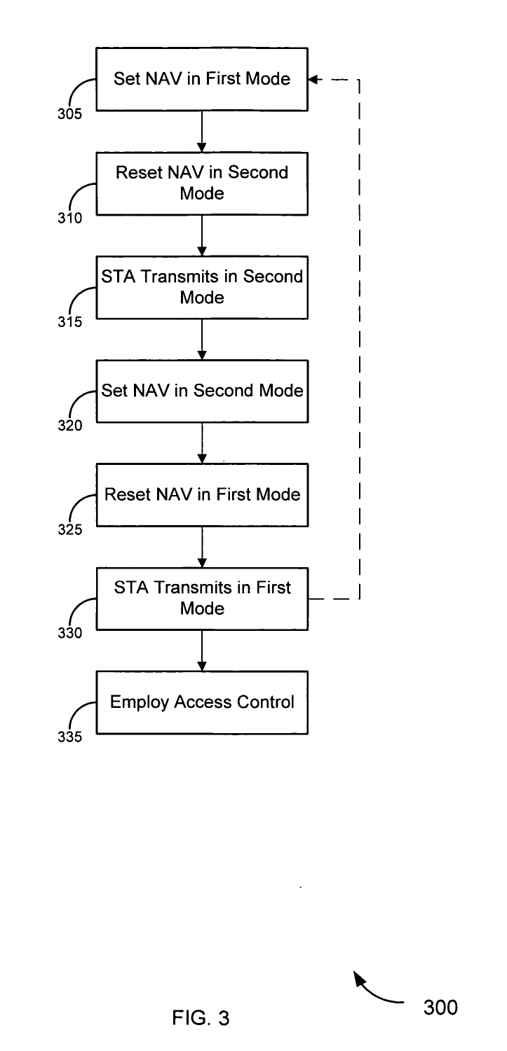

FIG. 3 illustrates another exemplary method 300 in accordance with an embodiment of the invention. The method 300 may be used to coordinate communications between one or more legacy stations and one or more extended range stations. FIG. 4 illustrates a timing diagram 400 in accordance with the method 300 of FIG. 3. (Although not illustrated on FIG. 4, it should be noted that each transmission may be preceded by a short inter-frame spacing (“SIFS”) as is known in the art.)

The method 300 may comprise an access point setting a network allocation vector (“NAV”) in a first station or set of stations (which may associated in a network portion, as described above) (block 305). (Although this document, for ease of description, refers to an access point setting/resetting a NAV in a station, e.g., using control frames, one skilled in the art will appreciate that, in many cases, the station will set/reset its own NAV, as appropriate, in response to the control frame. Hence, the station might be programmed to set its NAV values in response to control frames received from the access point and/or other stations.) Merely by way of example, the first station may be an extended-range station, and/or the access point may set the NAV by transmitting a communication in an extended-range protocol. (Alternatively, the first station or set of stations may be legacy station, and/or the communication may be transmitted using a basic mode). In a set of embodiments, a control frame, such as a clear-to-send-to-self (“CTS_to_Self”) frame may be transmitted. A CTS_to_Self frame generally will set the NAV in each node receiving the frame, thus setting a timer (which may be of a predetermined duration, perhaps with an additional random or pseudo-random “step-back” interval, as is known in the art) in each node; generally, the timer (or NAV) must expire before the node will again transmit on the network.

Since, however, the control frame is send via the first mode, nodes communicating via the second mode will not receive the control frame and thus the NAVs in such devices will not be set by the communication. Optionally, the access point may send an additional communication in the second mode to reset the NAV in nodes communicating via the second mode. An exemplary communication is a contention-free-end (“CF_End”) frame. The CF_End frame generally will function to reset the NAV in devices receiving the second communication (i.e., devices communicating via the second mode). Since resetting the NAV effectively sets the NAV to zero, such devices will assume they are free to transmit on the network.

One or more of the devices communicating via the second mode thus may transmit as necessary. In a set of embodiments, the operation of nodes communicating via the second mode may proceed as they would in a network consisting only of nodes configured to communicate via the second mode (e.g., with normal contention and/or transmission control procedures among such nodes).

At block 320, the access point may transmit a communication in the second mode to set the NAV in nodes communicating via the second mode. This procedure may be similar to that discussed above at block 305, except that the communication is transmitted in the second mode instead of in the first mode. This effectively closes the transmission “window” for devices operating in the second mode. Optionally, this procedure may be timed to coincide with the expiration of the NAV set at block 310. Alternatively and/or in addition, this procedure may be performed when the access point senses that the node(s) communicating via the second mode no longer need to transmit. The access point may then transmit a communication via the first mode to reset the NAV in nodes participating in the first mode of communication (block 325), effectively opening a transmission window for these nodes, as described above. One or more nodes operating in the first mode may then transmit any necessary packets (block 330), again in a similar fashion (albeit in a different mode) to the transmission of packet via the second mode as described with respect to block 315.

The procedures described in block 305-330 may be repeated, effectively establishing a set of alternating transmission windows for nodes operating in the second and first modes, respectively, to transmit packets on the network. Optionally, the access point may employ one or more access control schemes (block 335), including, without limitation, the QoS protocols described above. In particular embodiments, such access control schemes may determine the timing of the windows provided to the legacy and extended-range devices, respectively. Merely by way of example, if an access point employs HCCA, and a particular extended-range device informs the access point that it needs access to the network at a specified interval (and the access point grants such access, in accordance with the HCCA standard), the access point may set the NAV in legacy devices such that the extended-range device is guaranteed access to the network at the specified interval. Based on the disclosure herein, one skilled in the art will appreciate that other service requirements of various nodes may affect the timing of transmission windows in similar fashion.

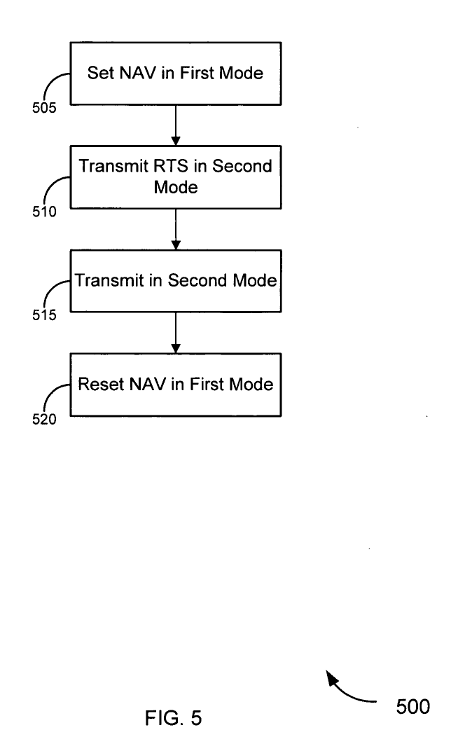

FIG. 5 illustrates a method 500 that may be used when an access point wishes to transmit to a particular station (and/or group of stations) on the network. In order to transmit to a node employing a second mode of communication (e.g., a legacy station), it may be necessary for the access point to prevent contention by nodes employing a first mode of communication (e.g., an extended-range station), which will not necessarily be aware of the transmission, since it may not be able to receive a communication via the second mode.

In accordance with the method 500, then, the access point may set a NAV via the first mode (for instance, using a CTS_to_Self transmission, as described above), which instructs nodes operating in the first mode not to transmit for the duration of the NAV.

Those skilled in the art will appreciate that even in a single-mode network, a “hidden node” situation may exist, whereby two or more nodes (one or more of which may be an access point) are not aware of each other's presence in the wireless network. This situation may occur in a dual-mode network as well. Merely by way of example, the access point might not be able to “see” all of the nodes operating using the second mode. Hence, the access point optionally may transmit a request-to-send (“RTS”) communication via the second mode of communication (block 510), in order to inform nodes operating via the second mode that the access point wishes to transmit.

The access point may then transmit the necessary data via the second mode for reception by the appropriate station (block 515). (It should be noted that certain embodiments may omit block 510, such that the access point transmits its data (block 515) without first sending an RTS in the second mode). In some cases, the transmission may not occupy the entire duration of the NAV set at block 505. Hence, the access point may transmit a communication (such as a CF_End frame, as discussed above) via the first mode, in order to reset the NAV on any nodes operating in the first mode, allowing those devices to transmit.

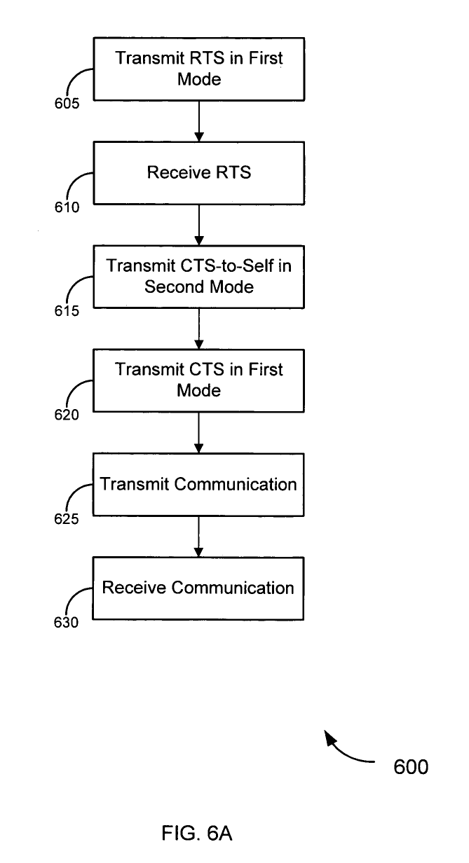

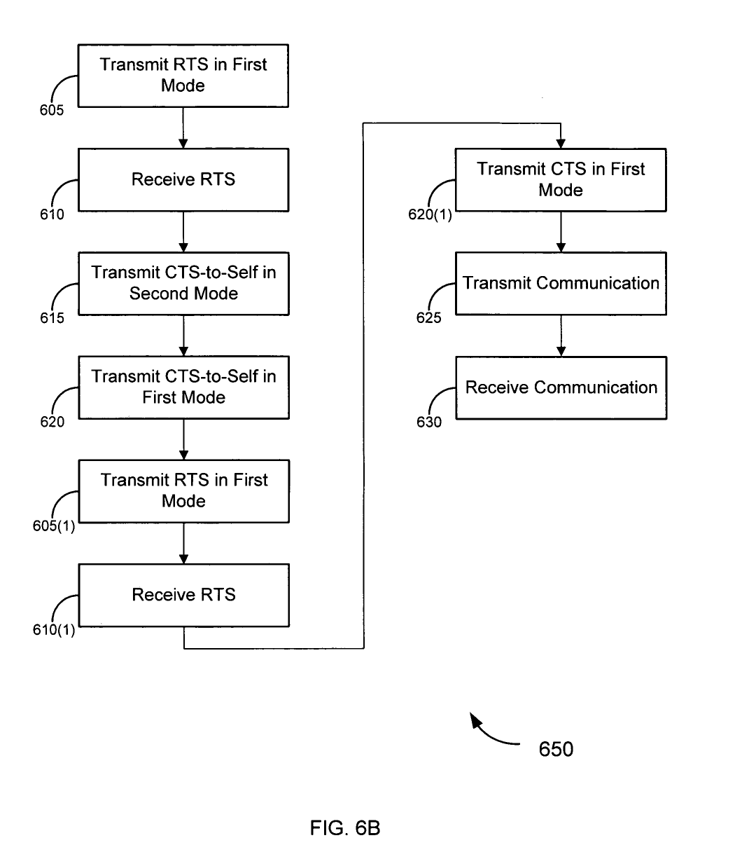

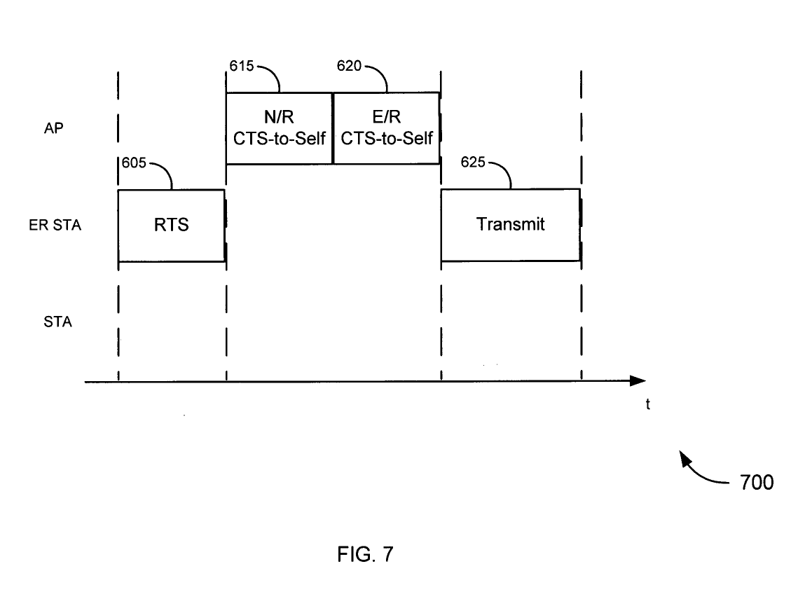

In some cases, a station may need to transmit data outside of an established transmission window for that station (and/or a network may not have established transmission windows for particular types of stations). FIG. 6 illustrates a method 600 that may be used to accommodate such needs. (FIG. 7 illustrates a timing diagram 700 in accordance with the method 600 of FIG. 6. As noted above with respect to FIG. 4, while not illustrated on FIG. 7, each transmission may be preceded by an appropriate Interframe space time, (such as a SIFS, DIFS, etc.) In accordance with this method 600, a station (e.g., a legacy station) may transmit an RTS message in a first mode (e.g., a basic mode) (block 605). Upon receiving the RTS message (block 610), an access point may transmit a CTS_to_Self message in a second mode (e.g., an extended-range mode) (block 615). The access point then transmits the CTS message in the basic mode (block 620). Upon receiving the CTS message, the station that requested permission to transmit will respond by transmitting the necessary packet(s) (block 625), which may be received by the access point and/or another appropriate node (block 630).

Optionally, upon detecting that the transmission has been completed (perhaps through an end-of-message indicator and/or a timeout), the access point may indicate to other nodes that the transmission is finished and that the other nodes may transmit as needed. Merely by way of example, the access point may transmit a message (such as a CF_End message, as described above) in the basic mode in order to reset the NAV in nodes operating in the basic mode. The access point may transmit a similar message in the extended-range mode, thus resetting the NAV in stations operating in the extended-range mode.

In some cases, rather than (and/or in addition) to implementing the procedures described with respect to FIG. 6B, the timeouts of the relevant stations may be adjusted. Merely by way of example, the CTS timeout of the requesting station may be set to cover the duration of the CTS-to-Self message. (For instance, the duration of the RTS may include a double CTS response). Similarly, the duration of the CTS-to-Self (in the second mode) may be specified in the beacon frame for the first mode and/or may be computed based on the worst rate advertised in the beacon basic rate set (“BRS”). As another example, the RTS NAV reset rule may specify a duration of, for instance, 2 SIFS, plus the duration of the CTS-to-Self, plus two slottimes.

Alternatively, as described above, if it is desired to re-establish transmission windows, the access point may transmit a CTS_to_Self or similar message via one of the modes and a CF_End or similar message via the other mode, such that nodes operating in the first mode may not transmit, while nodes operating in the second mode may transmit. A similar process may be used to prevent legacy stations from transmitting while permitting an extended-range station to transmit.

In some cases, the interval between when a station transmits an RTS message and when that station receives the CTS message authorizing the station to transmit may be sufficient to cause the station to timeout (for instance, the station might mistakenly determine that the RTS message was not received by the AP). In such cases, the station may transmit an additional RTS message. FIG. 6B illustrates an exemplary method 650 that accounts for such a scenario.

The method 650 is similar to the method 600 illustrated by FIG. 6A, except that the station may not wait for the CTS message transmitted in the first mode (block 620). Hence, the station may retransmit an RTS message (block 605(1)). Upon receiving the retransmitted RTS message (block 610(1)), the AP may recognize that the RTS is simply a retransmission from the station that sent the original RTS message (i.e., in block 605). In this circumstance, the AP may determine that it should not transmit another CTS-to-Self message (i.e., as in block 615), since the NAVs of stations operating in the second mode likely will not have expired from the original CTS-to-Self message, and the time required to transmit an additional CTS-to-Self message may cause the requesting station to timeout once again. Hence, the AP may proceed directly to transmit another CTS message in the first mode (block 620(1)). Upon receiving the CTS message, the requesting station may transmit its communication (block 625), and the method proceeds as described with respect to FIG. 6A.

In a set of embodiments, the exemplary methods described above may be implemented in conjunction. Merely by way of example, in normal operation, the network may operate according to the method 300 of FIG. 3, with alternating transmission windows for legacy devices. When the access point needs to transmit a communication to all nodes (such as a beacon frame, broadcast frame, etc.), the access point may interrupt this cycle with one or more of the communications described with respect to FIG. 2 (perhaps preceded by CTS_to_Self frames transmitted in the first and second modes).

Similarly, when the access point needs to transmit data to a particular extended range node (or set thereof), it may perform the sequence described with respect to FIG. 4, where the first mode is the basic mode and the second mode is the extended-range mode. Conversely, when the access point needs to transmit data to a particular legacy node (or set thereof), it may perform the method of FIG. 5, where the first mode is the extended-range mode and the second mode is the legacy mode. When the access point is finished with the transmission, it can resume the alternating transmission windows of FIG. 3, perhaps with a CTS_to_Self communication transmitted via the legacy mode and a CF_End communication transmitted via the extended-range mode (or vice-versa).

In other embodiments, the access point may use alternative procedures to control the transmissions of various stations (e.g., by selectively setting and/or resetting the NAVs in various stations, as described above). Merely by way of example, while several of the methods described above discuss the use of a CF_End message to reset a NAV, in other embodiments, an access point may use alternative procedures to reset the NAV of a station (which could be an extended-range station and/or a legacy station). One example is for the access point to transmit a CF_Poll frame with the receiving MAC address matching its own MAC address and a duration of 0. As another example, the methods described above often use a CTS-to-Self message to set the NAV of various stations. In alternative embodiments, the access point may instead send a CTS message to a nonexistent receiving address, such that receiving nodes will assume the nonexistent node has been authorized to transmit and will set their respective NAVs accordingly. Yet another procedure to set the NAV in various stations is to transmit a CF_Poll message (in the first and/or second mode as appropriate). Where possible, some network embodiments might allow simultaneous use of the network by both legacy stations and extended-range stations (e.g., if the ranges are such that the uses do not interfere, if RTS/CTS is required before transmission, etc.).

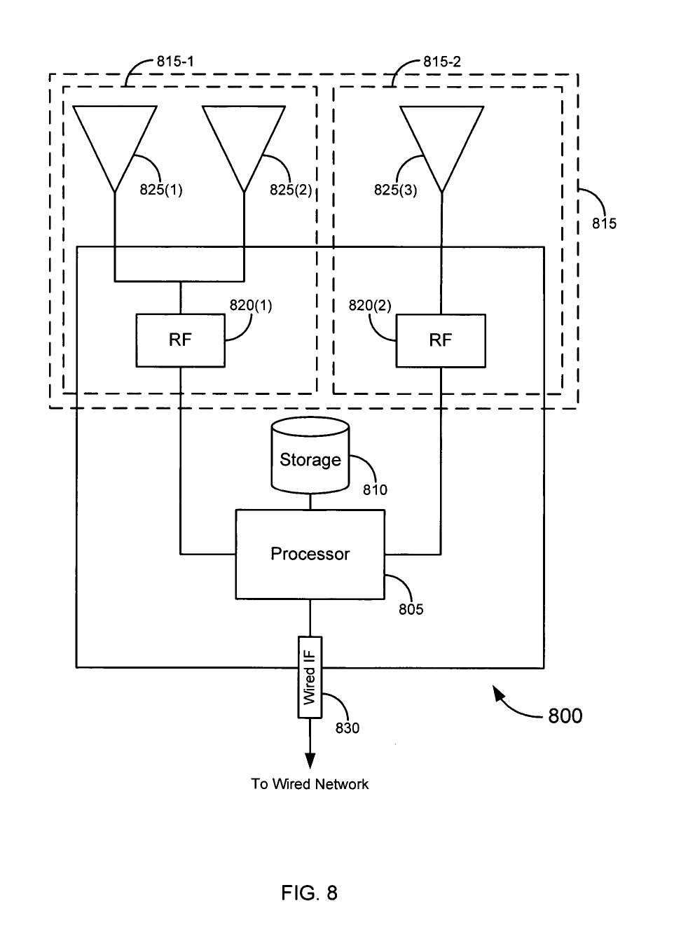

FIG. 8 illustrates a simplified schematic diagram of a wireless node 800 in accordance with embodiments of the invention. (The wireless node 800 may be an access point that is configured to communicate in both legacy and extended-range modes. Station nodes may comprise similar structures, although they may, in some cases, be configured to operate only in one mode.) The node 800 may include a processor 805 (and/or in some cases a plurality of processors) configured to perform various functions related to network communications, including, without limitation, the MAC layer control functions described herein. The processor 805 may be in communication with a storage device 810, which may comprise any appropriate volatile and/or non-volatile storage media, such as one or more memory devices (e.g., RAM devices, ROM devices, etc.), hard drives and/or the like. The storage device may store one or more software and/or firmware programs, which may comprise instructions that provide logic for performing the functions of the invention, including, without limitation, the methods described above.

The processor 805 also may be in communication with a communication system 815 that can provide connectivity with other wireless nodes, including, without limitation, one or more legacy and/or extended-range stations. In a set of embodiments, the communication system may comprise a first communication subsystem 815(1) and a second communication subsystem 815(2). The first communication subsystem, which may be used to provide communication with extended-range devices, may comprise appropriate RF circuitry 820(1) to allow a signal to be transmitted and/or received via one or more antennas 825(1), 825(2). (As noted above, many extended-range technologies, such as MIMO and/or STBC, employ multiple transmit and/or receive antennas). The second communication subsystem also comprises appropriate RF circuitry 820(2) to allow a signal to be transmitted and/or received via an antenna 825(3) (although a plurality of antennas could be used here as well).

In a set of embodiments, the functionality of subsystems 815(1) and 815(2) may be provided by a single system. That is, the same RF circuitry and/or antenna(s) may be configured to provide both extended-range mode and basic mode communications (and/or, if two antennas are used to provide extended-range mode communications, one of the two antennas maybe used to provide basic mode communications).

The processor 805 also may be in communication with an interface 830. In some cases (such as an access point), the interface may provide a wired network interface, such that the node may communicate with a wired network. In other cases (such as a station), the interface may provide communication with a device, such as a PDA, computer, wireless phone, etc.

While the invention has been described with respect to exemplary embodiments, one skilled in the art will recognize that numerous modifications are possible. For example, the processes described herein may be implemented using hardware components, software components, and/or any combination thereof. Thus, although the invention has been described with respect to exemplary embodiments, it will be appreciated that the invention is intended to cover all modifications and equivalents within the scope of the following claims.

What is claimed is:

1. In a wireless network comprising a plurality of wireless stations, the plurality of wireless stations comprising at least one basic-range wireless station configured to communicate via a basic mode of communication and at least one extended-range wireless station configured to communicate via an extended-range mode of communication, a device for allowing interoperability and/or coexistence of the plurality of wireless stations, the device comprising:
a communication system configured to provide wireless communication among the plurality of wireless stations including at least one basic-range wireless station and at least one extended-range wireless station;
a processor in communication with the communication system; and
a computer readable medium comprising a set of instructions executable by the processor, the set of instructions comprising:
a) instructions for transmitting a communication in a basic mode for reception by the basic-range wireless station; and
b) instructions for transmitting the communication in an extended-range mode for reception by the extended-range wireless station;
the instructions including signaling for coordinating use of the wireless network taking into account that not all of the plurality of wireless stations are assured of receiving communications from each of the other of the plurality of wireless stations due to the use of two modes of communication.

2. The device of claim 1, wherein the device comprises a wireless access point.

3. The device of claim 1, wherein the communication system comprises:
a first communication subsystem configured to provide wireless communication with the at least one basic-range wireless station; and
a second communication subsystem configured to provide wireless communication with the at least one extended-range wireless station.

4. The device of claim 1, wherein the extended-range mode employs space-time block coding (“STBC”).

5. The device of claim 1, wherein the plurality of wireless stations comprises a plurality of basic-range wireless stations configured to communicate via a basic mode of communication and a first plurality of extended-range wireless stations configured to communicate via a an extended-range mode of communication, wherein the set of instructions further comprises:
c) instructions for associating the plurality of basic-range wireless stations with a first portion of the wireless network; and
d) instructions for associating the first plurality of extended-range wireless stations with a second portion of the wireless network.

6. The device of claim 5, wherein the plurality of wireless stations further comprises a second plurality of extended-range wireless stations, each of the second plurality of extended-range wireless stations being configured to communicate via at least the basic-range mode of communication, and wherein the set of instructions further comprise:
e) instructions for associating at least a subset of the second plurality of extended-range wireless stations with the first portion of the wireless network.

7. The device of claim 1, wherein the communication comprises a beacon frame.

8. The device of claim 1, wherein the communication comprises a broadcast message.

9. The device of claim 1, wherein the communication comprises a multicast message.

10. In a wireless network comprising a plurality of wireless stations, the plurality of wireless stations comprising at least one basic-range wireless station configured to communicate via a basic mode of communication and at least one extended-range wireless station configured to communicate via an extended-range mode of communication, a device for allowing interoperability and/or coexistence of the plurality of wireless stations, the device comprising:
a communication system configured to provide wireless communication among the plurality of wireless stations including at least one basic-range wireless station and at least one extended-range wireless station;
a processor in communication with the communication system; and
a computer readable medium comprising a set of instructions executable by the processor, the set of instructions comprising:
a) instructions for setting a first network allocation vector (“NAV”) at the at least one extended-range wireless station;
b) instructions for resetting a second NAV at the at least one basic-range wireless station;
c) logic for receiving a communication transmitted by one of the at least one basic-range wireless station.

11. The device of claim 10, wherein the set of instructions further comprises:
d) instructions for setting the second NAV at the at least one basic-range wireless station;
e) instructions for resetting the first NAV at the at least one extended-range wireless station; and
f) instructions for receiving a communication transmitted by one of the at least one extended-range wireless station.

12. The device of claim 10, wherein the instructions for setting the first NAV comprises instructions for transmitting a communication control frame in the extended-range mode of communication.

13. The device of claim 12, wherein the communication control frame comprises a clear-to-send-to-self (“CTS_to_Self”) message.

14. The device of claim 10, wherein the logic for resetting the second NAV comprises logic for transmitting a communication control frame in a basic mode.

15. The method of claim 14, wherein the communication control frame comprises a contention-free-end (“CF-End”) message.

16. The device of claim 10, wherein the instructions further comprise:
logic for employing an access control protocol.

17. The device of claim 16, wherein the access control protocol is enhanced distributed channel access (“EDCA”).

18. The device of claim 10, wherein the set of instructions comprises instructions comprising microcode executable by the processor.

19. In a wireless network comprising a plurality of wireless stations, the plurality of wireless stations comprising at least one basic-range wireless station configured to communicate via a basic mode of communication and at least one extended-range wireless station configured to communicate via an extended-range mode of communication, a device for allowing interoperability and/or coexistence of the plurality of wireless stations, the device comprising:
a communication system configured to provide wireless communication among the plurality of wireless stations including at least one basic-range wireless station and at least one extended-range wireless station;
a processor in communication with the communication system; and
a computer readable medium comprising a set of instructions executable by the processor, the set of instructions comprising:
a) instructions for transmitting a first communication in a first mode, the first communication being operable to set a network allocation vector (“NAV”) at a first of the plurality of wireless stations; and
b) instructions for transmitting a second communication in a second mode for reception by a second of the plurality of stations;
wherein the first mode and the second mode are each selected from a group consisting of a basic-range mode of communication and an extended-range mode of communication.

20. The device of claim 19, wherein at least one wireless station communicating via the basic-range mode of communication is cannot receive communications sent via the extended-range mode of communication, and wherein at least one wireless stations communicating via the extended-range mode of communications cannot receive communications sent via the basic-range mode of communications.

21. The device of claim 19, wherein the first communication comprises a clear-to-send-to-self (“CTS_to_Self”) message.

22. The device of claim 19, wherein the instructions further comprise:
logic for transmitting a request-to-send (“RTS”) message in the second mode prior to transmitting the second communication.

23. The device of claim 19, wherein the NAV comprises a duration, wherein the second communication is completed before the duration of the NAV expires, and wherein the instructions further comprise:
c) instructions for transmitting a third communication in the first mode, the third communication being operative to reset the NAV, indicating that the device has completed the second communication.

24. The device of claim 23, wherein the third communication comprises a contention-free-end (“CF-End”) message.

25. In a wireless network comprising a plurality of wireless stations, the plurality of wireless stations comprising at least one basic-range wireless station configured to communicate via a basic mode of communication and at least one extended-range wireless station configured to communicate via an extended-range mode of communication, a device for allowing interoperability and/or coexistence of the plurality of wireless stations, the device comprising:
a communication system configured to provide wireless communication among the plurality of wireless stations including at least one basic-range wireless station and at least one extended-range wireless station;
a processor in communication with the communication system; and
a computer readable medium comprising a set of instructions executable by the processor, the set of instructions comprising:
a) instructions for receiving a first communication via a first mode from a first of the plurality of wireless stations, the first communication indicating that the first of the plurality of wireless stations has data to be transmitted to the wireless access point;
b) instructions for transmitting a second communication via a second mode, the second communication indicating that wireless stations other than the first of the plurality of stations should not transmit;
c) instructions for transmitting the second communication via the first mode, the second communication further indicating that the first of the plurality of wireless stations may transmit the data; and
d) instructions for receiving a third communication from the first of the plurality of wireless stations, the third communication comprising the data;
wherein the first mode and the second mode are each selected from a group consisting of a basic mode of communication and an extended-range mode of communication.

26. The device of claim 25, wherein at least one wireless station communicating via the basic-range mode of communication is cannot receive communications sent via the extended-range mode of communication, and wherein at least one wireless stations communicating via the extended-range mode of communications cannot receive communications sent via the basic-range mode of communications.

27. A wireless network, comprising:
a first wireless station configured to transmit a first communication via a first mode of communication, the first communication indicating that the first wireless station has data to transmit;
a second wireless station configured to communicate via a second mode of communication; and
a wireless access point comprising:
a communication system configured to provide wireless communication among the plurality of wireless stations including at least one basic-range wireless station and at least one extended-range wireless station;
a processor in communication with the communication system; and
a computer readable medium comprising a set of instructions executable by the processor, the set of instructions comprising:
a) instructions for receiving the first communication;
b) instructions for transmitting a second communication via the second mode, the second communication indicating that wireless stations other than the first wireless station should not transmit; and
c) instructions for transmitting the second communication via the first mode, the second communication further indicating that the first wireless station may transmit the data;
wherein the first wireless station is further configured to transmit the data upon receiving the second communication; and
wherein the first mode and the second mode are each selected from a group consisting of a basic mode of communication and an extended-range mode of communication.

28. The wireless network of claim 27, wherein at least one wireless station communicating via the basic-range mode of communication is cannot receive communications sent via the extended-range mode of communication, and wherein at least one wireless stations communicating via the extended-range mode of communications cannot receive communications sent via the basic-range mode of communications.

29. The wireless network of claim 27, wherein the first communication comprises a request-to-send (“RTS”) message.

30. The wireless network of claim 27, wherein the second communication comprises a clear-to-send (“CTS”) message.

31. The wireless network of claim 27, wherein the set of instructions further comprise:
d) instructions for transmitting a fourth communication in the first and second modes, the fourth communication indicating that the first wireless station has completed the third transmission.

32. The wireless network of claim 27, wherein the second communication is operative to set a network allocation vector (“NAV”) at the second wireless station.

33. In a wireless network comprising a plurality of wireless stations, the plurality of wireless stations comprising at least one basic-range wireless station configured to communicate via a basic mode of communication and at least one extended-range wireless station configured to communicate via an extended-range mode of communication, a method for allowing interoperability and/or coexistence of the plurality of wireless stations, the method comprising:
the wireless access point transmitting a first communication in a first mode, the first communication being operative to set a first network allocation vector (“NAV”) at a first wireless station;
the wireless access point transmitting a second communication in a second mode, the second communication being operative to reset a second NAV at a second wireless station; and
the wireless access point receiving a communication transmitted by the second wireless station;
wherein the first mode and the second mode are each selected from a group consisting of a basic mode of communication and an extended-range mode of communication.

34. The method of claim 33, wherein at least one wireless station communicating via the basic-range mode of communication is cannot receive communications sent via the extended-range mode of communication, and wherein at least one wireless stations communicating via the extended-range mode of communications cannot receive communications sent via the basic-range mode of communications.

35. In a wireless network comprising a plurality of wireless stations, the plurality of wireless stations comprising at least one basic-range wireless station configured to communicate via a basic mode of communication and at least one extended-range wireless station configured to communicate via an extended-range mode of communication, a method for allowing interoperability and/or coexistence of the plurality of wireless stations, the method comprising:
the wireless access point receiving a first communication in a first mode from a first of the plurality of wireless stations, the first communication indicating that the first of the plurality of wireless stations has data to be transmitted to the wireless access point;
the wireless access point transmitting a second communication in a second mode, the second communication indicating that wireless stations other than the first of the plurality of stations should not transmit;
the wireless access point transmitting the second communication in the first mode, the second communication further indicating that the first of the plurality of wireless stations may transmit the data; and
the wireless access point receiving a third communication from the first of the plurality of wireless stations, the third communication comprising the data;
wherein the first mode and the second mode are each selected from a group consisting of a basic mode of communication and an extended-range mode of communication.
